(19) United States
(12) Patent Application Publication
(10) Pub. No.: US 2015/0294101 A1
(43) Pub. Date: Oct. 15, 2015

(54) RUNNING APPLICATIONS, AND AUTHENTICATING USERS

(71) Applicant: TENCENT TECHNOLOGY (SHENZHEN) COMPANY LIMITED, Shenzhen (CN)

(72) Inventor: Yanjie WEN, Shenzhen (CN)

(21) Appl. No.: 14/752,378

(22) Filed: Jun. 26, 2015

Related U.S. Application Data
(63) Continuation of application No. PCT/CN2013/090837, filed on Dec. 30, 2013.

(30) Foreign Application Priority Data
Dec. 31, 2012 (CN) 201210589938.2

(51) Int. Cl. G06F 21/32; G06F 3/0481; G06F 3/041

(52) U.S. Cl. CPC G06F 21/32; G06F 3/0416; G06F 3/04817; G06F 2203/04104

(57) ABSTRACT

Various examples provide a method and an apparatus of running applications. When a user clicks on an icon of an application displayed on a touch screen, a fingerprint is collected. It is judged whether the collected fingerprint matches with a stored fingerprint. A user interface of the application is displayed if the collected fingerprint matches with the stored fingerprint. Various examples also provide a method and an apparatus of authenticating users. When a user clicks on an area for authentication in a user interface of an application displayed on a touch screen, a fingerprint is collected. It is judged whether the collected fingerprint matches with a stored fingerprint. It is determined the user has passed user authentication if the collected fingerprint matches with the stored fingerprint.

### CROSS-REFERENCE TO RELATED APPLICATIONS

This application is a continuation of International Application No. PCT/CN2013/090837, filed on Dec. 30, 2013, which claims priority to Chinese patent application No. 201210589938.2 titled “Method and apparatus of running applications” and filed on Dec. 31, 2012 with the Patent Office of the People's Republic of China, the disclosures of both of which are incorporated herein by reference in their entireties.

### TECHNICAL FIELD

The present disclosure relates to software, and particularly, to running applications, and authenticating users.

### BACKGROUND

Smart terminal devices, e.g., smart phones, tablet computers, are becoming popular electronic consumer products. Compared with conventional phones, a key feature of smart terminal devices (e.g., smart phones) is that: the screen of a smart terminal is not only a display device but also an inputting device, e.g., the capacitive touch screen is the most-often used inputting device in a smart phone. A user can control a smart device through simple or multi-touch gestures by touching the screen with one or more fingers, e.g., unlocking the device, scrolling the screen, zooming in or zooming out, starting an application by a single touch on an icon of the application displayed on the screen, inputting characters by using a virtual keyboard displayed on the screen, and so on.

### SUMMARY

Various examples of the present disclosure provide a method and an apparatus of running applications to improve data security of users.

According to an example, a method of running applications may include:

collecting a fingerprint when a finger clicks on an icon of an application displayed on a touch screen;

judging whether the fingerprint collected matches with a stored fingerprint, and displaying a user interface of the application if the fingerprint collected matches with the stored fingerprint.

According to an example, an apparatus of running applications may include:

a fingerprint collecting module, adapted to collect a fingerprint when a finger clicks on an icon of an application displayed on a touch screen; and

a fingerprint verifying module, adapted to judge whether the fingerprint collected matches with a stored fingerprint, and displaying a user interface of the application if the fingerprint collected matches with the stored fingerprint.

Various examples also provide a method and an apparatus of authenticating users.

According to an example, a method of authenticating users may include:

collecting a fingerprint when a user clicks on an area for authentication in a user interface of an application displayed on a touch screen;

judging whether the fingerprint collected matches with a stored fingerprint, and determining the user has passed user authentication if the fingerprint collected matches with the stored fingerprint.

According to an example, an apparatus of authenticating users may include:

a fingerprint collecting module, adapted to collect a fingerprint when a user clicks on an area for authentication in a user interface of an application displayed on a touch screen; and

a fingerprint verifying module, adapted to judge whether the fingerprint collected matches with a stored fingerprint, and determining the user has passed user authentication if the fingerprint collected matches with the stored fingerprint.

According to an example of the present disclosure, a non-transitory computer-readable storage medium may include a set of instructions for running applications. The set of instructions may cause at least one processor to perform the acts of:

collecting a fingerprint when a finger clicks on an icon of an application displayed on a touch screen;

judging whether the fingerprint collected matches with a stored fingerprint, and displaying a user interface of the application if the fingerprint collected matches with the stored fingerprint.

The above mechanism collects a fingerprint from a finger when the finger clicks on an icon of an application displayed on a touch screen and verifies the fingerprint, and the user interface of the application can only be displayed when the fingerprint is verified. Thus, privacy of user data is improved. The mechanism collects a fingerprint when a user clicks on a area for authentication in a user interface of an application displayed on a touch screen and verifies the fingerprint, and it is determined the user has passed user authentication when the fingerprint is verified. The mechanism makes full use of the touch screen technology to authenticate a user when the user touches the touch screen and thus frees users from inputting passwords for user authentication and reduces human-machine interactions required.

### BRIEF DESCRIPTION OF THE DRAWINGS

Features of the present disclosure are illustrated by way of example and not limited in the following figures, in which like numerals indicate like elements, in which:

FIG. 1 is a schematic diagram illustrating a communication system;

FIG. 2 is a schematic diagram illustrating modules of a terminal device;

FIG. 3 is a flowchart illustrating a method of running applications in accordance with an example of the present disclosure;

FIG. 4 is a flowchart illustrating a method of running applications in accordance with an example of the present disclosure;

FIG. 5 is a schematic diagram illustrating modules of an apparatus of running applications in accordance with an example of the present disclosure;

FIG. 6 is a schematic diagram illustrating modules of an apparatus of running applications in accordance with an example of the present disclosure;

FIG. 7 is a schematic diagram illustrating modules of an apparatus of running applications in accordance with an example of the present disclosure;

FIG. 8 is a schematic diagram illustrating modules of an apparatus of running applications in accordance with an example of the present disclosure;

FIG. 9 is a schematic diagram illustrating modules of an apparatus of running applications in accordance with an example of the present disclosure;

FIG. 10 is a schematic diagram illustrating modules of an apparatus of running applications in accordance with an example of the present disclosure;

FIG. 11 is a flowchart illustrating a method of running applications in accordance with an example of the present disclosure;

FIG. 12 is a schematic diagram illustrating modules of an apparatus of running applications in accordance with an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. Quantities of an element, unless specifically mentioned, may be one or a plurality of, or at least one.

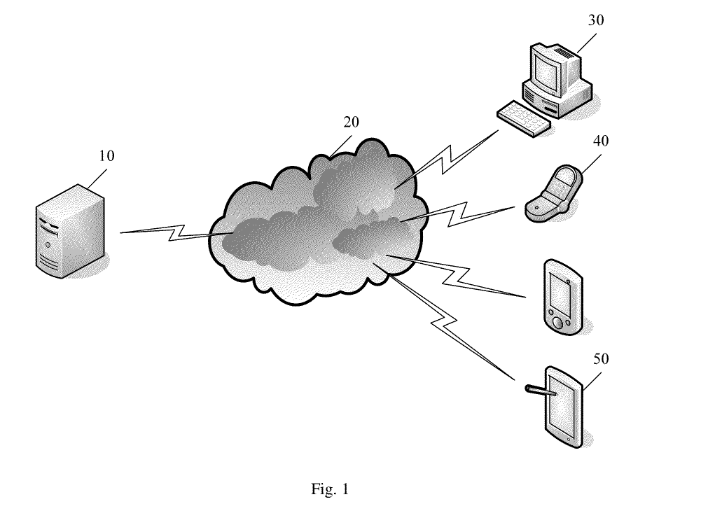

FIG. 1 is a schematic diagram illustrating a communication system. As shown in FIG. 1, the communication system includes a server 10, a communication network 20 and user terminal devices. A user terminal device may be a personal computer (PC) 30, a mobile phone 40, a tablet computer 50, or other types of mobile Internet devices (MID), such as an electronic book reader, a handheld game console and etc. that can access the Internet using a certain wireless communication technology. The user terminal device has a touch screen, and the method of various examples is applicable to the user terminal device.

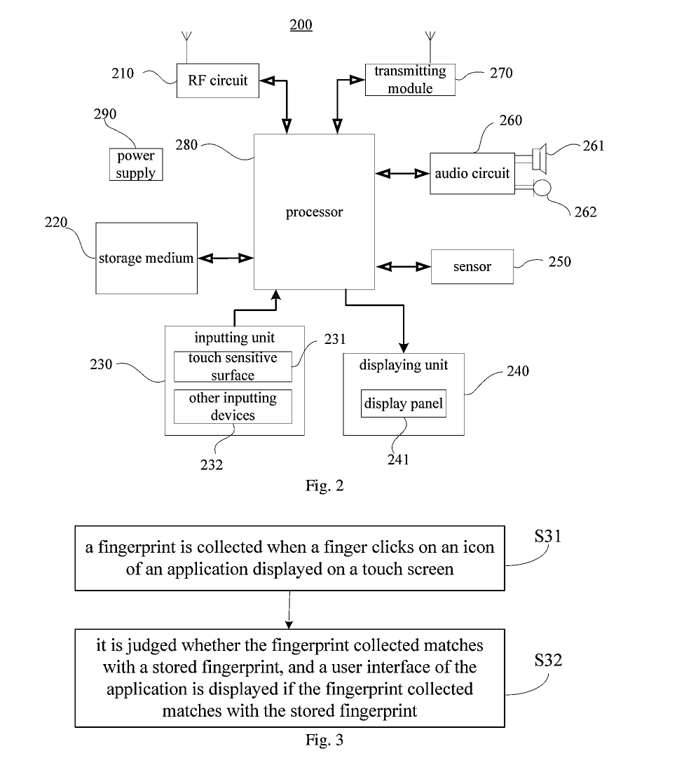

FIG. 2 is a schematic diagram illustrating modules of a terminal device; As shown in FIG. 2, a terminal device 200 may include: a radio frequency (RF) circuit 210, at least one computer-readable storage medium 220, an inputting unit 230, a displaying unit 240, a sensor 250, an audio circuit 260, a transmitting unit 270, at least one processor 280 and a power supply 290 and the like.

The RF circuit 210 is capable of sending and receiving signals during a process of information sending/receiving process or a voice communication process. In an example, the RF circuit 110 may send downlink information received from a base station to the at least one processor 280 for further processing, and may send uplink data to the base station. The RF circuit 210 may generally include, but not limited to, an antenna, at least one amplifier, a tuner, at least one oscillator, a subscriber identity module (SIM) card, a transceiver, a coupler, a low noise amplifier (LNA), a duplexer, and the like. The RF circuit 210 may perform wireless communications via a network with other devices. The wireless communications may be implemented by any communications standard or protocol including, but not limited to, Global System of Mobile (GSM) communication, General Packet Radio Service (GPRS), Code Division Multiple Access (CDMA), Wideband Code Division Multiple Access (WCDMA), Long Term Evolution (LTE), email, Short Messaging Service (SMS), and so on.

The storage device 220 stores software programs and modules, e.g., program instructions and modules corresponding to the firewall of examples of the present disclosure, and also stores data generated during the safety protection process of examples of the present disclosure. The processor 280 runs the software programs and modules stored in the storage device 220 to implement various functions and data processing to realize the mechanism of examples of the present disclosure. The storage device 220 may include an area storing programs and an area storing data. The area storing programs may store an operating system, at least one application program providing a function (e.g., audio playing function, video playing function and so on). The area storing data may store data generated during operation of the terminal device 200 (e.g., audio data, a phone book, etc.) and so on. The storage device 220 may include a high-speed random access memory, and may also include a non-transitory memory, e.g., at least one disk storage, flash memory or other non-transitory solid state storage device and the like. Correspondingly, the storage device 220 may also include a storage controller to provide the processor 280 and the inputting unit 230 with access to the storage device 220.

The inputting unit 230 may receive digits or characters inputted, and generate a keyboard input signal, a mouse input signal, a control lever input signal, an optical input signal, or a track ball input signal which is related with user settings and function controlling. In an example, the inputting unit 230 may include a touch sensitive surface 231 and another inputting device 232. The touch sensitive surface 231, also referred to as a touch screen or a touchpad, is capable of collecting touch operations performed by a user on the surface or near the surface (e.g., an operation performed on or near the touch sensitive surface 231 using any proper object or attachment such as a finger or a touch pen and etc.), and driving a connecting apparatus corresponding to the operation according to a pre-defined procedure. In an example, the touch sensitive surface 231 may include a touch detecting apparatus and a touch controller. The touch detecting apparatus detects the position touched by the user, detects a signal generated by the touch, and sends the signal to the touch controller. The touch controller receives touch information from the touch detecting apparatus, converts the touch information into coordinates of the touch position, sends the coordinates to the processor 280, receives a command sent by the processor 280 and executes the command. The touch sensitive surface 231 may be implemented via various types of touch techniques such as resistive touch screen, capacitive touch screen, infrared touch screen and surface acoustic wave touch screen and so on. In an example, the inputting unit 231 may include another inputting device 232 besides the touch sensitive surface 230. In an example, the inputting device 232 may include, but not limited to, at least one of a physical keyboard, a function key (e.g., a volume control key, a power on/off key and etc.), a track ball, a mouse, a control lever and the like.

The displaying unit 240 is capable of displaying information inputted by the user, information provided for the user and various graphical user interfaces of the terminal device 200. The graphical user interfaces may include any combination of graphics, texts, icons, videos. The displaying unit 240 may include a display panel 241. In an example, the display panel 241 may be implemented by Liquid Crystal Display (LCD), Organic Light-Emitting Diode (OLED) and the like. In an example, the touch sensitive surface 231 may overlay the display panel 241. When detecting a touch operation on or near the touch sensitive surface 231, the touch sensitive surface 131 sends the touch operation to the processor 280 to determine the type of the touch event. Then the processor 280 provides visual output on the display panel 241 according to the type of the touch event. The touch sensitive surface 231 and the display panel 241 may be two independent components respectively for input and output, and may also be integrated to provide input and output in various examples.

The terminal device 200 may also include at least one sensor 250, e.g., an optical sensor, a motion sensor, or other types of sensors. In an example, the optical sensor may include an ambient light sensor and a proximity sensor. The ambient light sensor may adjust the brightness of the display panel 241 according to the strength of ambient light. The proximity sensor may close the display panel 241 and/or the backlight when the terminal device 200 is held close to an ear. A gravity sensor is a type of motion sensor, may detect the amount of acceleration in multiple directions (typically XYZ-axis), the amount and the direction of gravity when kept in stationary, and can be used in applications which need to identify phone postures (such as auto screen rotation, games using the sensing result, magnetometer attitude calibration), features related with vibration identify (such as a pedometer, percussion) and the like. The terminal device 200 may include other sensors, e.g., a gyroscope, a barometer, a hygrometer, a thermometer, infrared sensors and the like, which are not listed further herein.

The audio circuit 260, the speaker 261 and the microphone 262 may provide an audio interface between the user and the terminal device 200. The audio circuit 260 may convert received audio data into electrical signals, and send the electrical signals to the speaker 261. The speaker 261 converts the electrical signals into sound and outputs the sound. The microphone 262 may convert collected sound signals into electrical signals which are received by the audio circuit 260. The audio circuit 160 converts the electrical signals into audio data, and sends the electrical signals to the processor 280 for processing. The processed audio data may be sent to another terminal device via the RF circuit 210, or be output to the storage device 220 for future processing. The audio circuit 260 may also include an ear jack providing communications between a peripheral earphone and the terminal device 200.

WiFi is a short-distance wireless communications technique. The terminal device 200 may adopt a WiFi module 270 to provide wireless broadband Internet access to enable a user to send and receive emails, browse webpages and access stream media and so on.

The processor 280 is a control center of the terminal device 200 which interconnects all of the components in the phone using various interfaces and circuits and monitors the phone by running or executing software programs and/or modules stored in the storage device 220 and calling various functions of the terminal device 200 and processing data. _{∘} The processor 280 may include one or multiple processing cores. The processor 280 may integrate an application processor and a modem processor. The application processor mainly handles the operating system, user interfaces and application programs, and etc., and the modem processor mainly handles wireless communications. The modem processor may be a standalone processor, not integrated into the processor 280.

The terminal device 200 may also include a power supply 290 (e.g., a battery) providing power for various parts. In an example, the power supply may be logically connected with the processor 280 via a power supply management system to implement functions such as charging, discharging, power management and the like. The power supply 290 may also include any components such as one or multiple AC or DC power supply, a recharging system, a power failure detection circuit, a power converter or inverter, a power status indicator and the like.

The terminal device 200 may also include a camera, a bluetooth module, and the like.

FIG. 3 is a flowchart illustrating a method of running applications in accordance with an example of the present disclosure. The method may include the following procedures.

At block S31, a fingerprint is collected when a finger clicks on an icon of an application displayed on a touch screen.

At block S32, it is judged whether the fingerprint collected matches with a stored fingerprint of a user, and a user interface of the application is displayed if the fingerprint collected matches with the stored fingerprint.

In an example, the procedure in block S32 is performed before the user interface of the application is displayed, i.e., the display of the user interface is deferred after the finger clicks on the icon and before it is judged whether the collected fingerprint matches with the stored fingerprint, and the user interface of the application is displayed only after it is determined that the collected fingerprint matches with the stored fingerprint.

In an example, the above method may be implemented by an operating system or a third party application in a terminal device. When it is determined the collected fingerprint matches with the stored fingerprint, the operating system or the third party application starts the application to have the user interface of the application displayed on the touch screen.

In an example, the above method may be implemented by the application whose icon is clicked. After a user clicks on the icon of the application displayed on the touch screen, the application may be started, defer displaying the user interface of the application before performing the procedure in block S32, and display the user interface only after determining the collected fingerprint matches with the stored fingerprint. If it is determined the fingerprint does not match with the stored fingerprint, the application may terminate itself, i.e., terminating a main process of the application, or may keep running without displaying the user interface on the touch screen. In this example, the application is started up by the click on the icon of the application on the touch screen, but the user interface of the application is not displayed at the time. Therefore, the user interface of the application is displayed only after the fingerprint is verified, and it seems to the user that the application is by then “started”.

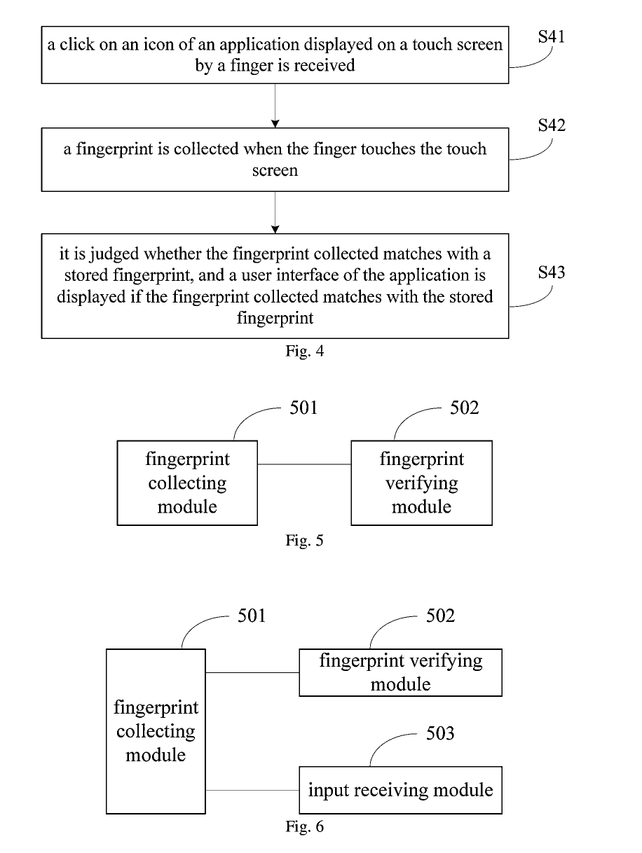

FIG. 4 is a flowchart illustrating a method of running applications in accordance with an example of the present disclosure. The method may be implemented by a user terminal device having a touch screen, e.g., a smart device and the like. The method may include the following procedures.

At block S41, a click on an icon of an application displayed on a touch screen by a finger is received.

The user terminal device (e.g., a smart phone) has a touch screen, e.g., a capacitive touch screen or a resistive touch screen, or the like. The touch screen is different from the screen of a conventional mobile phone in that it is not only a display, but also an inputting device. Therefore, when a user touches an icon of an application displayed on the touch screen using a finger, a click on the icon is received by the user terminal device which is then processed by software installed in the user terminal device (system software or application software).

At block S42, a fingerprint is collected when the finger touches the touch screen.

When a user wants to start an application installed in a smart device, the user may touch the touch screen to click on an icon of the application displayed on the touch screen.

For example, when a user wants to use QQ, an IM tool, the fingerprint of the user is collected when the user uses a finger to click on an icon of the QQ application.

At block S43, it is judged whether the collected fingerprint matches with a stored fingerprint of a user, and a user interface of the application is displayed if the collected fingerprint matches with the stored fingerprint.

In an example, a terminal device may record applications which have been configured by a user in advance to be started only after a fingerprint is verified. In an example, a terminal device may take it by default that each of all applications can only be started after a fingerprint is verified. After a click on an icon of an application is received, it may be judged whether the application needs fingerprint verification before startup, and the fingerprint collected is verified according to the above process if the application needs fingerprint verification before startup.

In an example, an application may record configuration of a user that the application first performs fingerprint verification before displaying a user interface of the application. After a click on an icon of the application starts the application, the application first judges whether the collected fingerprint matches with a stored fingerprint before displaying the user interface of the application.

In an example, the fingerprint may be verified in the terminal device or in a background server.

In an example, the procedure of judging whether the collected fingerprint matches with a stored fingerprint may include: storing a fingerprint of a user into the terminal device; comparing a fingerprint collected when the icon of the application is clicked with the fingerprint stored in the terminal device.

In an example, the collected fingerprint may be compared with a fingerprint stored in a database of the application. The application may have a database which stores a fingerprint of the user. When a finger touches the icon of the application, the fingerprint collected may be compared with the fingerprint stored in the database in the application. When the collected fingerprint matches with the fingerprint stored in the database in the application, the fingerprint is verified and the user interface of the application is displayed. When the fingerprint verification is implemented by the application, the application may start running after the user clicks on the icon of the application and defer display of the user interface before the fingerprint collected is verified. The application performs the fingerprint verification by using the fingerprint stored in the database, and displays the user interface only after the collected fingerprint is verified. When the fingerprint verification is implemented by an operating system or a third party application, the application may grant the operating system or the third party application with permissions of accessing the fingerprint stored in the database to enable the operating system or the third party application to perform the verification of the collected fingerprint by using the fingerprint stored in the database in the application.

In an example, the collected fingerprint may be compared with a fingerprint stored by a third party application. The third party application is installed in the terminal device and is connected with a fingerprint collecting module of the terminal device. When a finger touches the touch screen, a fingerprint collected from the finger is delivered to the third party application. Since the third party application has already had a fingerprint of the user when the third party application becomes connected with the fingerprint collecting module of the terminal device, the third party application may compare the collected fingerprint with the fingerprint stored in the third party application when the finger touches the touch screen. When the collected fingerprint matches with the fingerprint stored in the database in the third party application, the application is started.

In an example, the terminal device may deliver the collected fingerprint to a background server which compares the collected fingerprint with a fingerprint stored in the background server. The terminal device receives a verification result from the background server, and performs an action according to the verification result. The user of the terminal device may register at the background server via the terminal device in advance and store a fingerprint of the user into the background server. When the terminal device detects a finger is touching the touch screen, a fingerprint is collected and delivered to the background server. The background server compares the collected fingerprint with a stored fingerprint, and returns a verification result to the terminal device. After the verification result is received by the terminal device from the background server, the terminal device starts the application if the verification result indicates the collected fingerprint matches with the fingerprint stored in the background server. The background server may be a conventional background server or a Cloud server in a Cloud network. When the fingerprint verification is implemented by an application, the background server may be a background server of the application. When the fingerprint verification is implemented by an operating system or a third party application, the background server may be a background server of the operating system or of the third party application.

Various examples collect a fingerprint when a finger touches the touch screen to click on an icon of an application, a user can not perceive the fingerprint verification process. Therefore, the process which starts an application only after the fingerprint is verified does not increase the interaction between the user and the terminal device, but improves safety of user data.

FIG. 5 is a schematic diagram illustrating modules of an apparatus of running applications in accordance with an example of the present disclosure. The apparatus may be a terminal device having a touch screen. The apparatus may include a fingerprint collecting module 501 and a fingerprint verifying module 502.

The fingerprint collecting module 501 collects a fingerprint when a finger clicks on an icon of an application displayed on a touch screen.

The fingerprint verifying module 502 judges whether the fingerprint collected matches with a stored fingerprint, and displays a user interface of the application if the collected fingerprint matches with the stored fingerprint.

FIG. 6 is a schematic diagram illustrating modules of an apparatus of running applications in accordance with an example of the present disclosure. Only those features related with the implementation of the mechanism are illustrated for simplicity. The apparatus may be a terminal device having a touch screen and/or software in the terminal device, e.g., an operating system, the application to be started or a third party application. The apparatus may include a fingerprint collecting module 501, a fingerprint verifying module 502 and an input receiving module 503.

The input receiving module 503 receives a click by a finger on an icon of an application displayed on a touch screen.

The fingerprint collecting module 501 collect a fingerprint when the finger touches the touch screen.

When a user wants to start an application installed in the terminal device, the user may touch the touch screen to click on an icon of the application displayed on the touch screen of the terminal device.

The fingerprint collecting module 501 may collect the fingerprint when the user clicks on the icon, e.g., when a user uses a finger to click on an icon of QQ application (an IM tool) when a user wants to use the QQ application.

The fingerprint verifying module 502 judges whether the fingerprint collected matches with a stored fingerprint, and displays a user interface of the application if the collected fingerprint matches with the stored fingerprint.

In an example, the apparatus may also include a controlling module. The controlling module records applications that are configured by a user to be started only after a fingerprint is verified, or takes it by default that each of all applications needs a fingerprint verification process before startup. After receiving a click on an icon of an application by a finger, the controlling module may first judge whether the application needs a finger verification before startup, and triggers the fingerprint verifying module 502 to judge whether the fingerprint collected by the fingerprint collecting module 501 matches with a stored fingerprint if the application needs a fingerprint verification before startup.

In an example, the fingerprint may be verified in the terminal device or in a background server.

The above modules are merely examples of implementations of the mechanism of the present disclosure. It will be appreciated that some or all of the functions of the modules may be implemented by a set of different modules, i.e., the apparatus may have a different structure, according to the needs, such as requirement of hardware of the apparatus or for facilitating development of the software. In various examples, the modules may be implemented by hardware, or hardware together with proper software. For example, the fingerprint collecting module may be a hardware module capable of collecting a fingerprint when the finger touches the touch screen, e.g., a fingerprint entry device, or a general-purpose processor or other hardware capable of executing a computer program to implement the above functions; the fingerprint verifying module may be a hardware module capable of implementing the functions of the fingerprint verifying module, e.g., a fingerprint reader, or a general-purpose processor or other hardware capable of implementing the functions of the fingerprint verifying module. This applies to various examples.

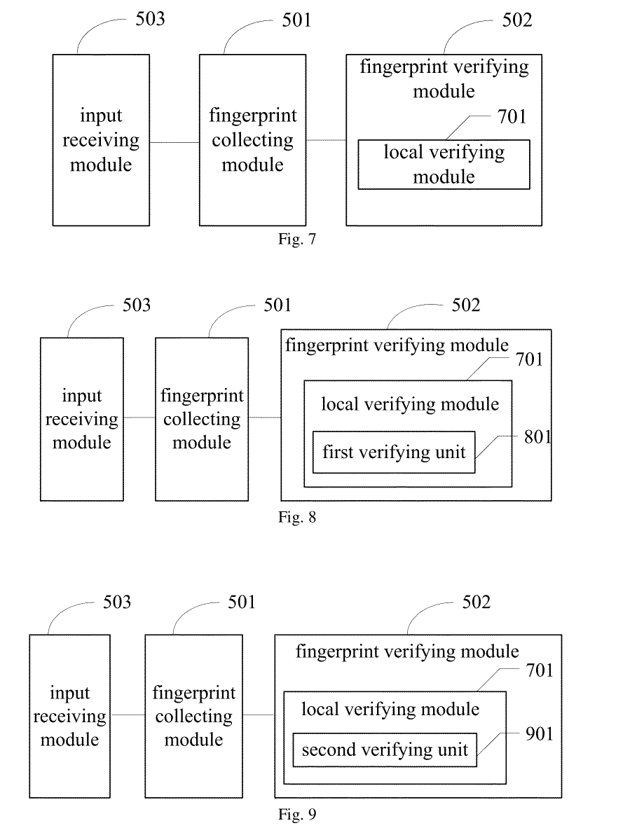

FIG. 7 is a schematic diagram illustrating modules of an apparatus of running applications. According to FIG. 7, the fingerprint verifying module 502 may include a local verifying module 701. The local verifying module 701 compares the fingerprint collected by the fingerprint collecting module 501 with a fingerprint stored in the apparatus. In an example, a fingerprint of a user may be stored in the apparatus in advance.

FIG. 8 is a schematic diagram illustrating modules of an apparatus of running applications. According to FIG. 8, the local verifying module 701 may include a first verifying unit 801. The first verifying unit 801 compares the fingerprint collected by the fingerprint collecting module 501 with a fingerprint stored in a database of the application. The application has a database which stores a fingerprint of a user. When a finger touches the icon of the application, the first verifying unit 801 compares the fingerprint collected by the fingerprint collecting module 501 with a fingerprint stored in a database of the application. When the first verifying unit 801 determines the collected fingerprint matches with the fingerprint stored in the database in the application, the user interface of the application is displayed.

FIG. 9 is a schematic diagram illustrating modules of an apparatus of running applications. According to FIG. 9, the local verifying module 701 may include a second verifying module 901. The second verifying unit 901 compares the fingerprint collected by the fingerprint collecting module 501 with a fingerprint stored by a third party application installed in the terminal device. In an example, the third party application is connected with the fingerprint collecting module 501 of the terminal device. When a finger touches the touch screen, a fingerprint collected from the finger by the fingerprint collecting module 501 is delivered to the third party application. Since the third party application has already had a fingerprint of the user when the third party application becomes connected with the fingerprint collecting module 501 of the terminal device, the second verifying unit 901 may compare the fingerprint collected by the fingerprint collecting module 501 with the fingerprint stored in the third party application when the finger touches the touch screen. When the second verifying unit 901 determines the collected fingerprint matches with the fingerprint stored in the third party application, the fingerprint collected is verified and the application is started.

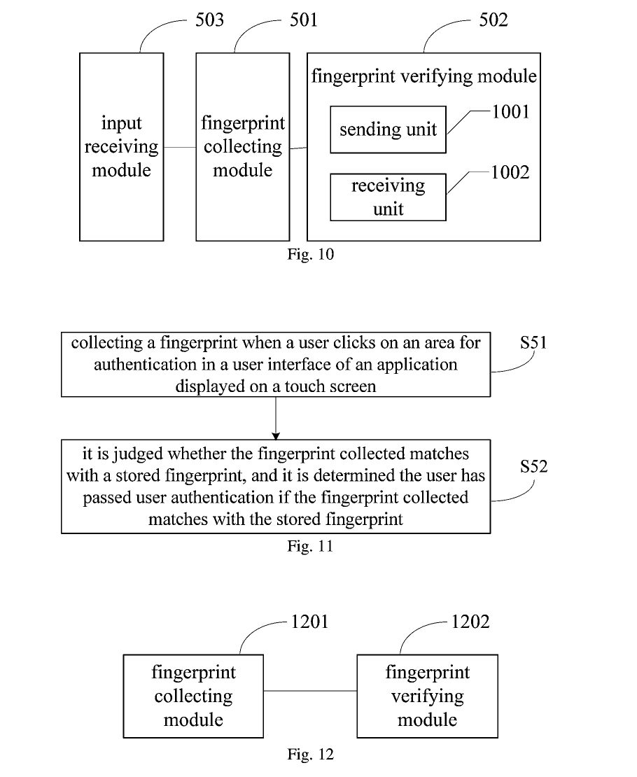

FIG. 10 is a schematic diagram illustrating modules of an apparatus of running applications. According to FIG. 10, the fingerprint verifying module 502 may include a sending unit 1001 and a receiving unit 1002.

The sending unit 1001 transmits the fingerprint collected by the fingerprint collecting module 501 to a background server which compares the collected fingerprint with a fingerprint stored in the background server.

The receiving unit 1002 receives a verification result returned by the background server after a fingerprint verification process is finished by the background server.

In the apparatus as shown in FIG. 10, the user of the terminal device may register at the background server via the terminal device in advance and store a fingerprint of the user into the background server. When the terminal device detects a finger is touching the touch screen, the fingerprint collecting module 501 collects the fingerprint of the finger, and the sending unit 1001 sends the fingerprint collected by the fingerprint collecting module 501 to a background server. The background server compares the fingerprint collected by the fingerprint collecting module 501 with a fingerprint stored in the background server, and returns a result of the comparing to the terminal device. The receiving unit 1002 of the terminal device receives the result returned by the background server. If the result returned by the background server indicates the collected fingerprint matches with the stored fingerprint, the user has passed the fingerprint verification, and a user interface of the application is displayed. In an example, the background server may be a conventional background server or a Cloud server in a Cloud network.

FIG. 11 is a flowchart illustrating a method of authenticating users in accordance with an example of the present disclosure. The method may include the following procedures.

At block S51, a fingerprint is collected when a user uses clicks on an area for authentication in a user interface of an application displayed on a touch screen.

At block S52, it is judged whether the fingerprint collected matches with a stored fingerprint, and it is determined the user is authenticated if the fingerprint collected matches with the stored fingerprint.

The method may be implemented by an application in the storage device 220 as shown in FIG. 2 together with proper hardware.

For example, a QQ application, which is an IM tool, needs a user name and a password for authenticating a user. After inputting a user name, the user may touch a password field displayed on the touch screen to have a fingerprint collected.

In an example, the terminal device may collect a fingerprint of the user when the user clicks on an area in a user interface of an application, and the application verifies the fingerprint, and judges the user has passed authentication if the collected fingerprint matches with a stored fingerprint. The application may compare the collected fingerprint with the stored fingerprint or send the collected fingerprint to a background server of the application for verification. The manner of verifying the fingerprint may be similar to that in the above examples, e.g., the application may perform the fingerprint verification by using a fingerprint stored in a database of the application, or the application may deliver the fingerprint to a third party application for verification, or send the fingerprint to a background server for verification, and the like.

In an example, when the fingerprint verification is performed in the terminal device, the application may send user identity information (e.g., a user name and a password) stored in the application to a background server of the application if the collected fingerprint matches with the stored fingerprint, and the background server authenticates the user by using the user identity information sent by the application.

In an example, a user may register his/her fingerprint at a background server via the application, and the background server may store the fingerprint of the user. When the application sends a fingerprint the collected from a user to the background server, the background server judges whether the collected fingerprint matches with the stored fingerprint, and determines the user is authenticated if the collected fingerprint matches with the stored fingerprint.

Compared with the conventional scheme in which a user has to input a password to be authenticated, the mechanism of the examples makes full use of the touch screen technology to authenticate a user when the user touches the touch screen and thus frees users from inputting passwords for user authentication and reduces human-machine interactions required.

FIG. 12 is a schematic diagram illustrating modules of an apparatus of authenticating users in accordance with an example of the present disclosure. The apparatus include the following components.

A fingerprint collecting module 1201 collects a fingerprint of a user when the user clicks on an area for authentication in a user interface of an application displayed on a touch screen.

A fingerprint verifying module 1202 judges whether the fingerprint collected matches with a stored fingerprint, and determines the user has passed user authentication if the collected fingerprint matches with the stored fingerprint.

In an example, the above apparatus may be an application in a terminal device, e.g., a browser, or a module/unit in an application.

In an example, the fingerprint collecting module 1201 may collect the fingerprint of the user when the user clicks on an area for authentication (e.g., a password field) in a user interface of the application. For example, a QQ application, which is an IM tool, needs a user name and a password for authenticating a user. After inputting a user name, the user may touch a password field displayed on the touch screen, and the fingerprint collecting module 1201 collects the fingerprint of the user.

The fingerprint verifying module 1202 may verify the fingerprint, and determine the user has passed user authentication if the collected fingerprint matches with the stored fingerprint. The fingerprint verifying module 1202 may compare the collected fingerprint with a stored fingerprint or send the collected fingerprint to a background server of the application for verification. The manner of verifying the fingerprint may be similar to that in the above examples, e.g., the fingerprint verifying module 1202 may perform the fingerprint verification by using a fingerprint stored in a database of the application, or the application may deliver the fingerprint to a third party application for verification, or send the fingerprint to a background server for verification, and the like.

In an example, when the fingerprint verification is performed in the terminal device, the fingerprint verifying module 1202 may send user identity information (e.g., a user name and a password) stored in the application to a background server of the application if the collected fingerprint matches with the stored fingerprint, and the background server authenticates the user by using the user identity information sent by the application.

In an example, a user may register his/her fingerprint at a background server via the application, and the background server may store the fingerprint of the user. When the fingerprint verifying module 1202 sends the collected fingerprint to the background server, the background server judges whether the collected fingerprint matches with the fingerprint stored in the background server, and determines the user passes the user authentication if the collected fingerprint matches with the stored fingerprint.

Various examples are based on a single general concept, thus the information interaction and processing carried out by the modules/units have the same technical merits as the method examples which are not repeated herein.

Some or all of the procedures of the methods provided by various examples, e.g., any of the following procedures, may be carried out by program codes executed by hardware:

collecting a fingerprint when a click on an icon of an application displayed on a touch screen is received; judging whether the fingerprint collected matches with a stored fingerprint; and displaying a user interface of the application if the fingerprint collected matches with the stored fingerprint; or

collecting a fingerprint of a user when a click on an area for authentication in a user interface of an application displayed on a touch screen is received; judging whether the fingerprint collected matches with a stored fingerprint; and determining the user has passed user authentication if the fingerprint collected matches with the stored fingerprint.

Those skilled in the art can understand that some or all of the steps of the methods provided by the embodiments may be implemented by hardware controlled by software. The software may be stored in a computer-readable storage medium. The storage medium may include: a Read Only Memory (ROM), a Random Access Memory (RAM), a magnetic disk or a compact disk, and the like.

According to an example of the present disclosure, a non-transitory computer-readable storage medium may include a set of instructions for running applications. The set of instructions may cause at least one processor to perform the acts of:

collecting a fingerprint when a finger clicks on an icon of an application displayed on a touch screen;

judging whether the fingerprint collected matches with a stored fingerprint, and displaying a user interface of the application if the fingerprint collected matches with the stored fingerprint.

It should be understood that in the above processes and structures, not all of the procedures and modules are necessary. Certain procedures or modules may be omitted according to the needs. The order of the procedures is not fixed, and can be adjusted according to the needs. The modules are defined based on function simply for facilitating description. In implementation, a module may be implemented by multiple modules, and functions of multiple modules may be implemented by the same module. The modules may reside in the same device or distribute in different devices. The “first”, “second” in the above descriptions are merely for distinguishing two similar objects, and have no substantial meanings.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

A machine-readable storage medium is also provided, which is to store instructions to cause a machine to execute a method as described herein. Specifically, a system or apparatus having a storage medium which stores machine-readable program codes for implementing functions of any of the above examples and which may make the system or the apparatus (or CPU or MPU) read and execute the program codes stored in the storage medium. In addition, instructions of the program codes may cause an operating system running in a computer to implement part or all of the operations. In addition, the program codes implemented from a storage medium are written in a storage device in an extension board inserted in the computer or in a storage in an extension unit connected to the computer. In this example, a CPU in the extension board or the extension unit executes at least part of the operations according to the instructions based on the program codes to realize the technical scheme of any of the above examples.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

The scope of the claims should not be limited by the embodiments set forth in the examples, but should be given the broadest interpretation consistent with the description as a whole.

What is claimed is:

1. A method of running applications, comprising:
collecting a fingerprint when a finger clicks on an icon of an application displayed on a touch screen; and
judging whether the fingerprint collected matches with a stored fingerprint, and displaying a user interface of the application if the fingerprint collected matches with the stored fingerprint.

2. The method of claim 1, wherein the judging whether the fingerprint collected matches with a stored fingerprint comprises:
comparing the fingerprint collected with a fingerprint stored in a terminal device that has the touch screen.

3. The method of claim 2, wherein the judging whether the fingerprint collected matches with a stored fingerprint comprises:
judging whether the fingerprint collected matches with a fingerprint stored in a database of the application.

4. The method of claim 2, wherein the judging whether the fingerprint collected matches with a stored fingerprint comprises:
judging whether the fingerprint collected matches with a fingerprint stored in a third party application.

5. The method of claim 1, wherein the judging whether the fingerprint collected matches with a stored fingerprint comprises:
sending the fingerprint collected to a background server which judges whether the fingerprint collected matches with a fingerprint stored in the background server; and
receiving a result returned by the background server.

6. The method of claim 1, wherein the displaying the user interface of the application comprises:
deferring displaying the user interface of the application after the finger clicks on the icon of the application and before judging whether the fingerprint collected matches with the stored fingerprint, and displaying the user interface of the application if the fingerprint collected matches with the stored fingerprint.

7. An apparatus of running applications, comprising: a processor and a memory, wherein the memory comprises a series of instructions executable by the processor to carry out the actions of:
collecting a fingerprint when a finger clicks on an icon of an application displayed on a touch screen; and
judging whether the fingerprint collected matches with a stored fingerprint, and displaying a user interface of the application if the collected fingerprint matches with the stored fingerprint.

8. The apparatus of claim 7, wherein the judging whether the fingerprint collected matches with a stored fingerprint comprises:
judging whether the fingerprint collected matches with a fingerprint stored in the apparatus.

9. The apparatus of claim 8, wherein the judging whether the fingerprint collected matches with a stored fingerprint comprises:
judging whether the fingerprint collected matches with a fingerprint stored in a database of the application.

10. The apparatus of claim 8, wherein the judging whether the fingerprint collected matches with a stored fingerprint comprises:
judging whether the fingerprint collected matches with a fingerprint stored in a third party application.

11. The apparatus of claim 7, wherein the judging whether the fingerprint collected matches with a stored fingerprint comprises:
sending the fingerprint collected to a background server which judges whether the fingerprint collected matches with a fingerprint stored in the background server; and
receiving a result returned by the background server.

12. The apparatus of claim 7, wherein the memory further comprises instructions executable by the processor to carry out the actions of:
deferring displaying the user interface of the application after the finger clicks on the icon of the application before judging whether the fingerprint collected matches with the stored fingerprint, and displaying the user interface of the application if the fingerprint collected matches with the stored fingerprint.

13. A method of authenticating users, comprising:
collecting a fingerprint when a user clicks on an area for authentication in a user interface of an application displayed on a touch screen; and
judging whether the fingerprint collected matches with a stored fingerprint, and determining the user has passed user authentication if the fingerprint collected matches with the stored fingerprint.

14. The method of claim 13, wherein the judging whether the fingerprint collected matches with a stored fingerprint comprises:
comparing the fingerprint collected with a fingerprint stored in a terminal device that has the touch screen.

15. The method of claim 14, wherein the judging whether the fingerprint collected matches with a stored fingerprint comprises:
judging whether the fingerprint collected matches with a fingerprint stored in a database of the application.

16. The method of claim 14, wherein the judging whether the fingerprint collected matches with a stored fingerprint comprises:
judging whether the fingerprint collected matches with a fingerprint stored in a third party application.

17. The method of claim 13, wherein the judging whether the fingerprint collected matches with a stored fingerprint comprises:
sending the fingerprint collected to a background server which judges whether the fingerprint collected matches with a fingerprint stored in the background server; and
receiving a result returned by the background server.
